(19) United States
(12) Patent Application Publication
(10) Pub. No.: US 2007/0039883 A1
(43) Pub. Date: Feb. 22, 2007

(54) Water separation system

(76) Inventor: Donald R. Glynn, Toronto (CA)

Correspondence Address: D.W. EGGINS, 18 DOWNSVIEW DRIVE, BARRIE, ON, L4M 4P8, CA

(21) Appl. No.: 11/589,234

(22) Filed: Oct. 30, 2006

Related U.S. Application Data
(63) Continuation-in-part of application No. 10/733,331, filed on Dec. 12, 2003.
Application No. 10/733,331 is a continuation-in-part of application No. 10/050,712, filed on Jan. 18, 2002, now abandoned.

(51) Int. Cl. B01D 65/02

(52) U.S. Cl. 210/636; 210/639; 210/650; 210/206; 210/209; 210/101; 210/95; 210/321.69

(57) ABSTRACT

Waste oily water is dewatered by expelling water through ceramic ultra filtration membranes of a cross-flow filter, located in a circulation ring, which is routinely cleaned in situ. The ring has two auxiliary reservoirs, with removable sight glasses, between which reservoirs the cleaning fluid is see-sawed during cleaning cycles, the reversing chemical flow being controlled by float switches. Heating for cleaning purposes is by way of closed-loop high-rate ring circulation. Frequent automated cleaning by a Programmable Logic Controller (PLC) maintains high flux rates with sustainable large volume annual throughput in the range of 1 to 2 million litres per year per square meter of filter membrane surface area. The system is fail-safe and environmentally friendly.

This application is a continuation-in-part of application Ser. No. 10/733,331 filed Dec. 12, 2003, which is a continuation-in-part of application Ser. No. 10/050,712 filed Jan. 18, 2002, which are both directed to a system comprising a method and apparatus for separating oil and water from industrial oily wastewaters, and are both incorporated herein by way of reference. In particular, the present system is directed to the separation of water from machining cutting coolant oils, die release agents, oily wash waters, and other emulsified oils, wherein the filter element is systematically and economically cleaned.

### STATEMENT REGARDING FEDERALLY SPONSORED RESEARCH OR DEVELOPMENT

NOT APPLICABLE

### BACKGROUND OF THE INVENTION

The above-identified prior Application which is incorporated herein by way of reference, teaches of the present need for the provision on-site of effective systems for the economic separation of water from oily wastewater. The prior applications also discuss current systems and their respective limitations. The prior Applications of the subject inventions teach the effective use of cross-flow ceramic filters by means of which the desired oil/water separation is effected.

The treatment industry has long held that Ultra Filtration (UF) membranes will not work over long periods of time on the types of oily wastes that are now routinely dealt with by the subject apparatus and methods.

The present inventor has earlier disclosed unique systems for membrane surface cleaning using various cleaning chemicals in sequence both in cross-flow across the membranes as well as chemical back-pulsing through the membranes so as to maintain it in effective operation.

An earlier embodiment utilized Pyrex (T.M.) reservoirs, which experienced problems from the high system pressures that are sometimes encountered in the cleaning cycles. Due to the nature of the oily wastes being treated, fouling of the reservoir walls could impede their sight-glass function.

### BRIEF SUMMARY OF THE INVENTION

The purpose of the present invention is to mechanically treat oily water, containing low concentrations of oil in the order of ½% to 6% by volume, typically, to separate the oil from such oily water, by extracting substantially oil-free water as a permeate. The concentrated oil is then readily disposed of.

The present invention provides a significantly improved and simplified apparatus having at least one processing “ring”, (formerly referred to as a “loop”), and utilizes ultra-filtration modules that are significantly improved over the current industry standard. The subject filter modules per se are automatically cleaned in-situ using various cleaning solutions in sequence and on demand as part of the regular operation of the processor. As a consequence, unprecedented levels of filtration and treatment of waste oily waters are readily achieved. This stand-alone, labour-free, auto-cleaning system has achieved market acceptance.

Multiple filter modules can be economically integrated with a single PLC (Programmable Logic Controller) to provide a range of filtering capacities to suit the bulk disposal requirements of respective manufacturing plants, wherein the water content is reduced by about 95%, with a corresponding reduction in shipping and disposal requirements, and their associated costs.

The subject process continuously circulates oily water around the ring, as permeate water is extracted (and sent to drain), until the oil concentration in the ring is increased to just under 35% oil. At this concentration, the volume of oily liquids and the corresponding costs of their disposal are significantly reduced.

This 30+% oil concentration generated by the processor can be further concentrated to about 90-95% oil by gravitational settlement, simply leaving it in a tank for the water to settle out. Sulfuric acid can be used in a tank to “shock” this oily concentrate emulsion which will hasten the break-up of the emulsion. The resultant oily water that “drops out” of the oily concentrate can be simply reintroduced into the processor, and re-processed. The present process may achieve processor output oil concentrations as high as about 40 volume percent.

However, filter membrane contamination tends to escalate at oil concentrations higher than 40%. In the case of a typical raw-feed oil/water concentration of 2% oil, the achievement of an oil concentration of 40% means that approximately 95% of the initial water content has been stripped from the feed and sent to drain or otherwise re-utilized, with corresponding savings in disposal costs of the residual oily concentrate that is left, and conservation of water.

The subject filter module per se is the same as that disclosed in the prior applications, having a stainless steel housing containing a ceramic cross-flow filter element, wherein the radial clearance between the ceramic filter element and housing may be effectively minimized, in order to reduce the respective volume/volumes of cleaning solution necessary for effective reverse flow and forward flow of the cleaning solutions used to flush clean the membrane surface of the filter module or modules.

The cleaning liquids in some instances may be returned to the respective reservoir, for re-use, with consequent annual savings in the cost of cleaning chemicals. Certain cleaning liquids, such as hydrogen peroxide are unsuitable for re-use, and are disposed of after one use. Owing to the reduced cleaning frequency of the subject cycle, the cleaning materials may be passed to drain. When, after a cleaning cycle the respective cleaning liquid is returned to its respective reservoir, this is effected by the use of an air purge acting through the top of the ring, which drives the cleaning solution downwards and out of the ring bottom and back to its reservoir. The same air purge applied at the ring top is also used as the initial displacement medium before any filling/re-filling of the ring.

Liquid materials removed from the ring may be either oily water, cleaning solutions, or rinse waters used after each cleaning cycle.

As in the prior applications, the filter element per se has a permeable sintered cylindrical alumina body having a number of circular bores (“lumens”) in mutually parallel relation with the primary axis of the cylinder. Each of the lumens has a peripheral surface membrane filter coating of fine zirconium and/or titanium oxide crystals, which permits the cross-flow passage of water therethrough, when subject to a pressure differential in the order of about 35 to 60 psi (pounds per square inch), while simultaneously serving to block the passage of oil, which flows along the face of the membrane, thus staying within and re-circulating through the lumens and the ring.

The membrane surfaces have a pore size in the ultra-filtration range of about 0.01 micron, however slightly larger or smaller pore size membranes can be used.

Pressures higher than 60 psi tend to lead to fouling of the membrane surface. The concentration of oil circulating in the ring increases steadily, as the water content is depleted, with clear permeate water leaving the ring after passing through the membrane filter. Oily water is continuously added as a make-up volume to replace this permeate water.

Periodically a valve opens, directing concentrated oily water out of the ring, and allowing in-flow of make-up oily water, to effect a lowering of the oil concentration in the ring.

It is preferable to keep the oil concentration in the ring at or under 35% oil concentration by volume, to minimize fouling of the filter surface.

The feed of oily water to the filter ring is automated by way of a pressure tank having a centrifugal pump in-feed that operates in response to the operation of low-level and high-level float switches located within the tank, with tank pressurization being controlled by an air inlet regulator and valve working in conjunction with an air dump valve. The operation to refill the pressure tank is controlled by the PLC controller which activates air in/out valves and the re-fill pump, based on the logic states of the two (high and low) float switches inside the pressure tank as it cycles during normal processing operations.

An improved oscillating cleaning system, relating to the cleaning cycle/cycles was previously adopted, which provides the capability of through-flushing cleaning solutions through the pores of the membrane of the filter element/elements in both directions. A settable timer within the PLC may initiate the cleaning cycles.

Alternately and preferably, a cleaning cycle is initiated when the permeate production rate falls below a preset minimum flow, averaged over time, as monitored by a paddle-wheel style flow meter.

When a cleaning cycle is initiated, the ring is drained of oily water by air blow down, then filled with tap water, which is re-circulated for a short time as a rinse, drained with air blown-down, and the ring then filled with an appropriate cleaning solution

A double O-ring seal is used in the subject filter modules, to seal the ceramic filter element to its stainless steel housing, to ensure that no oily residue passes from the ring side of the processor to the clear water permeate side of the system, as a consequence of repeated pressurized back and forth pulsing of cleaning fluids, previously found on occasion to have caused displacement of singular O-ring seals.

The subject system includes “power-failure” provisions which incorporate a normally-open air safety valve that is energized during normal operation of the system, and held in a closed condition, thereby excluding safety air pressure.

In the event of a power failure the safety valve becomes de-energized and opens, thereby admitting (safety) air pressure, which applies back-pressure to the permeate (filtered, oil-free) water that would normally flow out of the system. A normally-closed valve directing permeate water to drain is held open during normal processing and is teed to the air safety valve. During an electrical power-off situation this permeate drain valve closes, allowing the air safety valve (now open) to back-pressure permeate water in a reverse direction to the normal system pressure, to protectively suffuse the filter membrane surface with oil-free permeate. Oil droplets in the oily water would otherwise foul the filter membrane surface on a shut-down, by their tendency, under system pressure, to move into the membrane, in the absence of circulatory flow cross-flow in the ring due to the loss of power and consequent loss of pumping action.

The “oscillating” cleaning system has two small volume reservoirs associated with the ring. One reservoir is located at the ring top position and the other is located at the module top position, connected to the clean water permeate out-line, thus having the filter membrane connected between them. The primary purpose of these two reservoirs is to receive cleaning solutions which are oscillated between them. Cleaning solutions thus are moved through the membrane surfaces in passing from one reservoir to the other by means of air pressure.

Previously, the reservoirs were of borosilicate glass (Pyrex T.M.), which was found to have undesirable pressure limitations, being unable to accept the higher pressures that occasionally occur during certain aspects of the cleaning cycle Thermal glass was used in earlier embodiments because its transparency assisted in commissioning the processor as well as in trouble-shooting any problems that might occur in the various programmed cleaning cycles.

In order to meet system pressure requirements Schedule 80 CPVC (Chlorinated Poly Vinyl Chloride) pipe and pipe fittings were adopted which allows a temperature of 80 Celsius and a pressure of 100 PS, both being values within the desired upper limits for the UF process during a cleaning sequence as well as lying within the design parameters of the pipe material.

The need to have a visual liquid level reference is achieved by using an attached sight glass made from extruded clear Teflon tube which is held in place by polyethylene compression fittings The sight glass is connected to the Oscillating Reservoir. Additionally the sight glass is designed for ease of cleaning. Due to the nature of the oily wastes treated, interior surfaces become dirty and non-transparent. End plugs above and below the sight glass enable rapid cleaning of the sight glass interior with a swab once stop valves are closed, to isolate the sight glass from the rest of the processor. The sight glass assembly is attached to the opaque Oscillating Reservoir proper by brass compression fittings and copper tube Brass pipe fittings attached to the Reservoirs complete the attachment of the assembly.

Within the Reservoir a double float switch is integral to the oscillating action of the cleaning cycle. Float switch wires lead from each Reservoir to the PLC controller. Oily waste water or cleaning solutions enter and leave the Reservoir at upper and lower accesses There is a restricted flow area that connects the top of the Reservoir at the brass tee fitting (nipple), where the stem of the double float passes through the centre of this pipe nipple but does not impede the flow of liquid through this area. An additional feature of this embodiment is the use of a removable threaded reducer bushing fitting to secure the top of the Reservoir. The disconnection function of the reducer bushing may also be achieved by using either a “pipe union” type of fitting or alternately a “flange” connection. Float switches, over time, become coated with oil and dirt which changes the specific gravity of the floats to the point where they will no longer float in water and hence a ‘level’ signal can fail to reach the PLC. In the earlier Pyrex glass embodiment, the glass tube was held in place by four corner rods compressing the glass tube against gasketed end plates. This proved exceedingly time consuming to clean as total disassembly was required. Re-assembly required very critical re-torquing of the corner connecting rods. The subject embodiment with its removable reducer bushing enables periodic checking of the floats, with a processor downtime of a few minutes only.

Each reservoir contains a stainless steel float switch to signal the PLC controller when cleaning solution has passed from one reservoir as it empties, through the membrane, and into the opposite reservoir until it fills.

Upon start-up from a totally empty condition, the PLC will cause the processor ring and its related top located reservoir to fill with water, until the float switch within that reservoir is activated.

In carrying out the cleaning cycles, the various cleaning solutions also fill to the same level in the ring top position reservoir, thereby assuring that the ring is filled with liquid before the start-up of the re-circulation pump that moves liquid around the ring. Filling of the system is controlled by the PLC working in combination with the float switches.

One function of the PLC controller is to monitor the output rate of clear treated permeate water from the ring. This output rate is averaged over a period of time, on account of normal fluctuations in the rate of filtration that may take place other than as a consequence of fouling of the filter during normal operation.

Initiation of a cleaning cycle takes place when the clear water output rate falls below a predetermined (and re-settable) value, as recorded by the PLC.

The preferred cleaning cycle method involves the admission of a selected one of the available cleaning fluids from its respective reservoir, to fill the ring and the top mounted ring reservoir with the fluid. The ring is then isolated from all inward or outward flow of liquids by closure of the access solenoid valves, and the ring pump is run. Due to the absence of liquid transfer (input or output from the ring), the temperature of the cleaning fluid within the sealed ring rises quite rapidly, due to frictional heat generation. During this phase of the cleaning process, there is effectively no flow through the filter membrane, with the cleaning solution merely being pumped around the ring, along the lumens of the filter so as to heat the ring and the solution within. Upon reaching a predetermined elevated temperature, as determined by a temperature transducer, the cleaning cycle per se commences. The cleaning fluid is passed from the full ring reservoir under air pressure and outwardly through the filter membrane and moves to the other reservoir which is venting to atmosphere. This movement of hot solution continues until the fluid has transferred between the reservoirs, by traversing the filter membrane.

The sight glasses of the two reservoirs provide a visual reference of each transfer cycle, with one reservoir emptying while the other fills. After an appropriate delay, for the cleaning liquid to carry out its cleaning function, the transfer is then reversed, by reversal of the pressure gradient, to effect a to-and-fro or “see-saw” transfer of the cleaning liquid between the ‘ring’ reservoir through the membrane surfaces and into the ‘module’ reservoir. Operation of the reverse transfer or see-saw oscillation of cleaning solution is controlled by actuation of the liquid level sensor float switch in the “receiving” reservoir, by way of a signal to the PLC. A temperature transducer connected to constantly sense the ring liquid temperature sends a 4-20 mA (milli Amp) signal to the PLC which determines when to initiate cross-membrane flow once the correct elevated temperature for the cleaning solution re-circulating in the ring is reached. This cycle is repeated a (adjustable) number of times, to complete one of the available phases of filter cleaning.

It is usual practice to flush the ring with clean water before and after each chosen cleaning solution cycle.

The system has a number of cleaning solutions each with its respective solution reservoir, and a control system to enable selective sequential administration of the solutions, in accordance with demonstrated need. The sequencing of these chemical cleaning operations is operator-selectable, either on-site or from a remote control location, by use of a communication modem.

During all these cleaning sequences the ring pump is still running and heating the ring to even higher temperatures which facilitates cleaning efficiency. When a predetermined safe upper temperature limit for the respective cleaning liquid is reached, the signal from the temperature transducer causes the PLC to shut down the ring pump, putting a stop to the temperature rise. With the pump stopped, the oscillation of cleaning solution between the two reservoirs continues until the pre-set number of oscillations is achieved.

While a system employing up to four different cleaning solutions is disclosed herein, it will be understood that systems having a greater or a lesser number of such cleaning solutions are contemplated, and considered as coming within the ambit of this invention.

The system incorporates a number of pressure relief valves, to relieve untoward pressure spikes. One source for generating such a pressure spike may be the use of a cleaning solution that has the capability of gassing-off, associated with its cleaning activities, thereby creating a high rate of pressure build-up, which is accentuated by the elevated ring temperatures generated during cleaning. An example of potential high rate gas generation is during the use of hydrogen peroxide, used as a cleaning agent for certain stubborn contaminants, wherein rapid oxygen gas release can occur. A contributing factor to this generation of high rate pressure spikes is the heating up of this cleaning solution and its attack on organic contaminants which takes place due to the cleaning solution being repeatedly circulated around the process ring. during the initial part of the cleaning cycle.

Control of the operation of the subject system in separating water from oily water, and also in the operation of an available sequence of cleaning cycles is effected by the PLC, which commences the process sequence when oily water is made available for processing, i.e. when it is deposited into the main waste oily water storage tank, which causes a master float switch to rise and transmit a signal to the PLC.

The PLC re-boots itself automatically, in the event of a power loss/power return situation.

In addition to operating the separation process, and the processing ring cleaning cycles, the PLC can also store production data, which can be transmitted to a central facility via telephone, enabling remote monitoring and control of system operation.

The PLC may monitor other processing site parameters such as storage tank volumes, leaks, and error situations.

A single remote operator can readily monitor/control many such systems.

In operation, the PLC is programmed to initiate a cleaning cycle/cycles when the process output rate falls to a pre-determined threshold low value.

When the filter starts to foul (plug-up), with consequent reduced throughput, the process threshold low rate occurs, initiating a signal to the PLC. The PLC activates a first cleaning cycle that is normally adequate to restore the process rate to a value above the threshold value. In the event, after a predetermined lapsed time, that the process rate is still too low, and fails to meet the predetermined threshold permeate water volume throughput, the PLC then initiates a second-phase cleaning cycle, which is a repeat of the first cleaning cycle, but followed afterwards with a different, second cleaning solution cycle. If this again proves inadequate to restore the process rate, a further, third cleaning solution is cycled through the ring, and so on. In light of the significance of effective cleaning on the efficient operation of the cross-flow filter process, the apparatus has particular provisions for enabling systematic cleaning cycles; and the apparatus is connected so as to minimize loss of the respective cleaning fluids. This leads to very significant cost savings in cleaning chemicals, and is ecologically beneficial. To that end, the fill-up (up-flow) and drain-down flow path junctures are profiled and inclined, to concentrate the flow of liquid, particularly in the case of cleaning liquids, and in the case of the up-flow filling portion of the cycle, to obviate air-lock blockage by the entrapment of air bubbles.

The present invention provides a dewatering system for separating substantially clean liquid from a mixture of the liquid and a contaminating substance intimately mixed with the liquid, consisting of a circulation ring to receive the contaminated liquid in contained relation therein; the ring having a circulation path for circulating passage of contaminated liquid therearound; liquid transfer means for transferring the contaminated liquid into the circulation ring; pump means for circulating the contaminated liquid about the ring circulation path; cross-flow filter means having UF filter membrane surfaces forming a part of the ring circulation path, for receiving the liquid in cross-flow penetrating relation thereacross; liquid receiver means for receiving the penetrating liquid from the filter means; pressurizing means for creating a predetermined pressure drop across the cross-flow filter means, to promote passage of the liquid through the filter means; chemical cleaning means for cleaning the filter means; and control means for admitting chemicals of the cleaning means to the ring and removing the chemicals from the ring.

The subject contaminated mixture is a mixture of water with oil.

The subject chemical cleaning means includes a plurality of chemical reservoirs, the control means including individual control means for each of the reservoirs, wherein the cleaning means are connected with at least two auxiliary reservoirs, one auxiliary reservoir being connected directly with the ring, and one auxiliary reservoir being directly connected with the liquid receiver means, for passage of the chemical cleaning means to one auxiliary reservoir and through the filter membrane surfaces to the other auxiliary reservoir, wherein the control means provides forward and reverse flow between the two auxiliary reservoirs and through the filter membrane surfaces, in cleaning relation therewith.

The system auxiliary reservoirs each have a sight-glass removably connected therewith, to provide visual reference to the level of liquid within the connected reservoir, and to facilitate cleaning of the sight-glass.

The system auxiliary reservoirs each have a readily removable end cover portion, to provide ready access within the reservoir for purposes of maintenance.

The system cross-flow filter means consists of a single ceramic cross-flow filter element held within a stainless steel housing.

transferring the contaminated liquid into the circulation ring; pump means for circulating the contaminated liquid about the ring circulation path, when energized; cross-flow UF filter means having UF filter membrane surfaces forming a part of the ring circulation path, for receiving the liquid in cross-flow penetrating relation thereacross; liquid receiver means for receiving the penetrating liquid from the filter means; pressurizing means for creating a predetermined pressure drop across the cross-flow filter means, to promote passage of the liquid through the filter means; and back pressure means, operable on de-energization of the pump means, to terminate passage of the liquid through the filter means, and to apply backpressure to liquid within the liquid receiver means to thereby suffuse the liquid over the UF filter membrane surfaces, in protective relation from the contaminated liquid.

The system backpressure means includes a compressed air reservoir in actuating relation with an outlet valve for the liquid receiver means and with an inlet valve connected in back-pressure applying relation with the liquid receiver means.

The invention provides a method of extracting substantially clear permeate liquid from a contaminated mixture of the liquid and a low concentration of globular contaminant, using a cross-flow UF filter located within a circulatory ring apparatus containing the mixture, including the steps of filling the ring with the contaminated mixture; circulating the mixture around the ring at a sufficient pressure to promote the passage of the liquid as a permeate through the filter in a first direction, while maintaining the passage of the contaminant across the face of the UF filter; removing the permeate from the apparatus; draining the ring; admitting a cleaning liquid to the ring, and circulating same about the ring under a pressure acting to effect passage of said liquid in a first direction; reversing the pressure to effect passage of the liquid in a direction reverse to the first direction as a cleaning oscillation; repeating the cleaning oscillation; draining the cleaning liquid from the ring; readmitting contaminated mixture to the ring, and repeating the steps.

The method includes the step of rinsing the ring with water prior to the initial filling step; and rinsing with water again, after draining the cleaning liquid from the ring.

The method includes the step of monitoring the removal of the permeate, to determine the rate of permeate through-put in relation to a thresh-hold level, and initiating a cleaning sequence commencing with the step of draining the ring, to promote the rate of permeate throughput.

The method includes the step of further monitoring the removal of the permeate, to determine the rate of permeate through-put in relation to the thresh-hold level, and initiating a further cleaning sequence commencing with the step of draining the ring, to further promote the rate of permeate throughput.

The method step of circulating the mixture around the ring includes electrically energizing a pump means to circulate the mixture; including, in the event of said pump means becoming de-energized, the steps of terminating the removal of permeate from the apparatus, and applying air pressure to the apparatus to displace the permeate in suffusing relation across the face of the UF filter, in protective relation with the face of the UF filter.

The subject system is very flexible in terms of providing a range of filter arrangements with a corresponding available range of annual throughputs of treatment volumes.

Thus different systems, each mountable within the standard cabinet, consisting of one or more rings containing standard ring elements, may have annual nominal throughputs as shown (in litres of clean output water per year):

| | Low | High |
|---|---|---|
| 1) 1-pump and 1-filter | 500,000 L/year | 1,000,000 L/year |
| 2) 2-pumps and 2-filters | 1,000,000 L/year | 2,000,000 L/year |

Furthermore it is envisioned that two filters may be run in series in each ring driven by one re-circulation pump. This scenario should give the following annual production rates of permeate water:

| | Low | High |
|---|---|---|
| 1) 1-pump and 2-filter | 800,000 L/year | 1,500,000 L/year |
| 2) 2-pumps and 4-filters | 1,600,000 L/year | 3,000,000 L/year |

A second filter module placed in series and driven by the same pump as the first filter module will give a diminished return of produced permeate water compared to the first filter due to a drop in pressure which occurs as the re-circulating oily water exits the first filter. It is water pressure that drives permeate water through the filter, and depending on the ceramic filter element type, its array of lumens (bores), and their diameters, differing Delta P (pressure drop) values will obtain.

Wider (and fewer) lumens within a filter element of equal diameter will prove less restrictive to the passage of re-circulating oily water and hence will offer less resistance and create less pressure drop.

From the two charts above and in terms of equivalent filter performance, these production figures demonstrate a membrane filter rate substantially in the range of 1 to 2 million litres per year per square meter of filter membrane surface area, a value significantly in excess of present normal expectations with existing technologies when treating contaminated chemically bound oily emulsions containing dirt and particulates.

Filter (“flux”) flow rates have been consistently achieved by the subject process, in the range of 250 to 350 LMH (litre/square metre/hour), with such oily emulsions.

The main processor's PLC controller is capable of controlling many more processing rings than the two rings used in the standard set-up. The PLC can control outlying, electrically and hydraulically connected “slave” processing rings housed in a separate cabinet/cabinets.

In such a multiple set-up individual rings would process oily water until the permeate flow meter of an individual processor ring signals that it requires a cleaning sequence. The cleaning sequence would then be initiated for that ring. Any other processor ring subsequently signaling for a cleaning cycle would simply “wait in line” until the preceding ring had completed its cleaning cycle.

In this way one PLC controller can accommodate many processors.

The plant is substantially fail-safe, and environmentally friendly.

While the present disclosure is directed to the separation of water from oily water by way of an improved mode of cross-flow filtration, it will be understood that the contributions of the present invention may readily apply to mixtures of other materials, and their separation.

### BRIEF DESCRIPTION OF THE SEVERAL VIEWS OF THE DRAWING

Certain embodiments of the present invention are shown by way of illustration, without limitation of the invention thereto, other than as set forth in the present claims, reference being made to the accompanying drawings, wherein:

FIG. 1 is a schematic front elevation of a processing apparatus in accordance with the present invention, having a pair of rings, each with a single cross-flow filter unit;

FIG. 1A is a perspective cross-section of the filter, taken at A-A of FIG. 1;

FIG. 2 is a representational view similar to FIG. 1, of a subject apparatus having a single cross-flow filter unit in its ring, and mounted within a cabinet;

FIG. 3 is a schematic side elevation, in partial section, of the oily water feed reservoir portion of the FIG. 1 embodiment;

FIG. 4A is a schematic side elevation view similar to FIG. 2, showing a cabinet-mounted two-ring, filter system embodiment. The left ring is a single filter embodiment and the right ring is a double filter embodiment;

FIG. 4B is a schematic elevation as a rear view of FIG. 4A, showing the processor system support apparatus, located in the reverse side of the cabinet;

FIG. 5 is a plan view of the cabinet contents of the FIGS. 4A and 4B embodiment;

FIG. 6 is a diametrical section, in elevation of one of the sight-glass ring reservoirs;

FIG. 7 is a schematic side view of a detail portion of the cleaning solution reservoirs and rinse water circulation system;

FIGS. 8-12 are block diagrams showing the basic steps of the subject process; and,

FIG. 13 is a side elevation of another embodiment of ring reservoir, having a removable sight glass.

### DETAILED DESCRIPTION OF THE INVENTION

In the following description, the term “normally-closed” indicates that in a power-off condition the valve in question would close. Correspondingly the term “normally-open” indicates that in a power-off condition the valve in question would open.

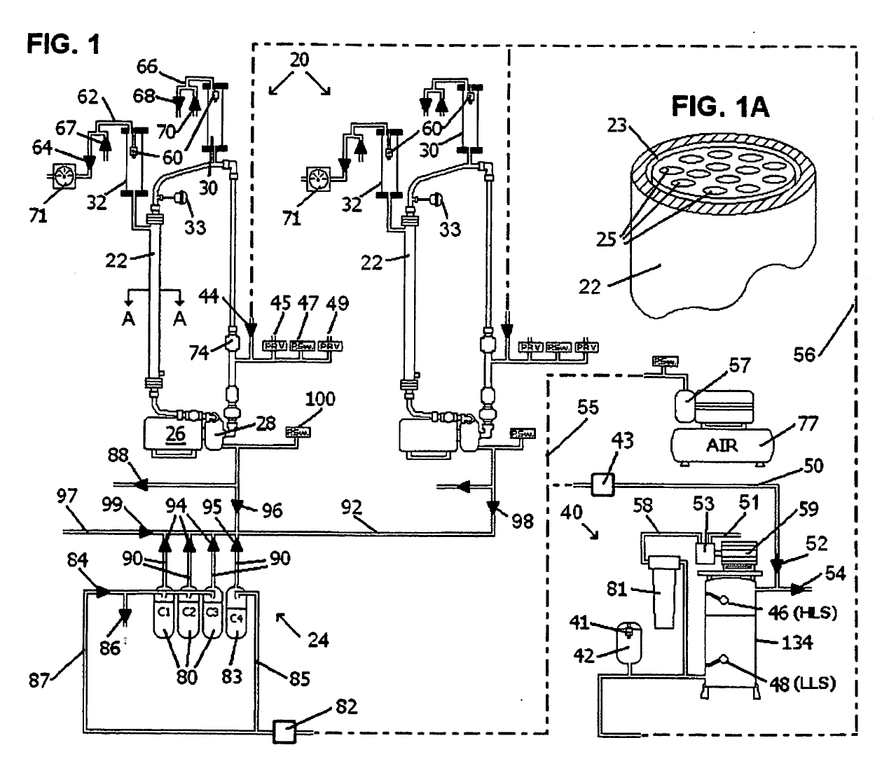

Referring to FIG. 1, two rings 20 are shown, each having a single filter unit 22. The rings 20 are generally housed within the same cabinet (not shown) and are serviced from a series 24 of cleaning liquids, C1 through C4. The description and numerals applied to the left hand ring 20 are generally identical for the right hand ring 20.

In FIG. 1A, the location of the lumens within the filter 22, and their membrane filter coatings 25 are shown, together with the permeate water (filtrate) collection annulus 23.

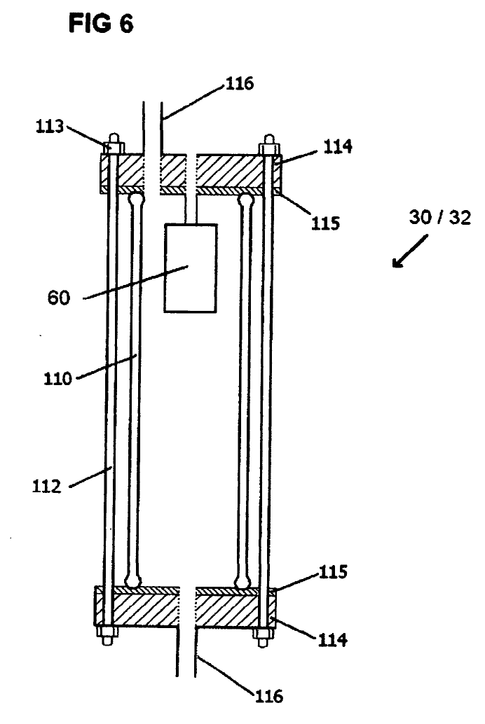

Each ring 20 includes an electric motor 26 driving a ring re-circulation pump 28, which normally circulates oily water through the central lumens 25 of the filter 22 (see FIG. 1A) and around the ring 20. Each ring 20 has a first sight-glass reservoir 30 attached by pipe at the top of each ring 20 (see also FIG. 6) which, when processing, contains oily water. A second sight-glass reservoir 32 is connected with the outlet side 23 of the filter 22, and receives clear water that has passed radially outwardly from the ring, through the multiple membranes 25 fused to the lumens (channels) of the filter 22 (FIG. 1A). Oily water feed from a pressurized feed system 40 passes by way of connection 56 into the ring 20, being admitted on demand through a normally closed solenoid valve 44. During normal processing operation of the ring 20, oily water is introduced through valve 44 and clear permeate water, essentially free of oil, exits through reservoir 32, past normally closed valve 64 and finally out through permeate water meter 71 before leaving the system.

During shut-down the membrane surfaces of the lumens 25 enclosed in filter module 22 need to be protected from fouling with oil. Fouling of membrane surfaces normally occurs on shutdown when cross-flow velocity of oily water traveling through the lumens, across membrane surfaces, is lost while the ring is still under pressure. In these circumstances microscopic oil droplets move radially outwards onto the surfaces 25, fouling the membrane. This is prevented in the subject system, when normally-closed valve 64 (which is held open during processing) closes due to power loss. This closure locks all process permeate water within the system and at the same time normally-open valve 67 (held closed during processing) now opens due to loss of power. Behind valve 67 is pressurized air acting inwards, being at least equal to the ring 20 pressure (acting outwards). This applied air pressure suffuses clear permeate water over the membrane surfaces of the lumens 25, so that the membrane surfaces of lumens 25 are protected from any tendency of the oil droplets in the ring to adhere to, or to migrate through the membrane.

The ring 20, has a safety line in case of the generation of undue pressure spikes, most likely associated with a cleaning operation. This safety line includes a first, high pressure release valve 45 (H.P. PRV), a pressure switch 47 and a second, low pressure relief valve 49 (L.P. PRV) which sustains pressure a sufficient time for the interposed pressure switch 47 to actuate if the ring 20 pressure exceeds a set safe maximum. During a cleaning operation cycle using hydrogen peroxide from tank 83, the pressure in the ring can build up very rapidly, from oxygen gas released under conditions of heat and agitation and the associated rapid oxidation of organic contaminants present in the ring. In the occurrence of such a pressure “spike”, the operation of the first, inboard H.P.PRV 45, (set at 80 psi) protects the processor. The second, L.P. PRV 49, (set at 30 psi) sustains back pressure long enough for the pressure switch 47, (set at 20 psi) and located between the two PRVs, to operate, so as to signal the PLC to shut down the ring pump, thereby terminating its heat generating function. During a normal cleaning cycle high heat alone determines when the circulation pump 28 shuts down upon triggering the temperature transducer 33. However when using hydrogen peroxide two different triggers can shut down the circulation pump 28. The temperature transducer 33 is one and pressure switch 47 is the other. The pressure generated on occasion when using hydrogen peroxide to clean membranes in an enclosed ring can generate destructive pressures very quickly at elevated temperatures as oxygen gas is released during cleaning as organic contaminants are oxidized. During high pressure spikes pressure switch 47 is triggered and untoward pressure is released out PRV 49. The moment switch 47 sends a signal to the PLC pump 28 is shut down.

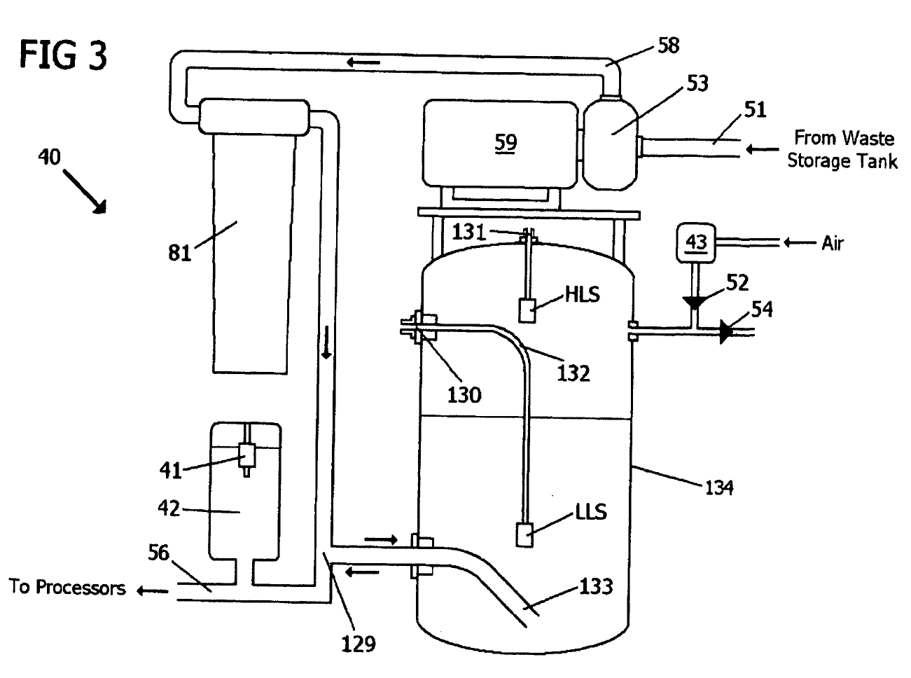

The oily water reservoir tank 134 (see also FIG. 3) is a pressure vessel having a high level switch (HLS) 46 and a low level switch (LLS) 48, which control the level of oily feed water within the tank 134. A pressure air line 50 with normally-open valves 52, and normally-closed dump valve 54, are used to pressurize the tank 134, and to depressurize it when being re-filled or made-up with oily feed water.

The feed water delivery line 56 which connects to the rings 20 has a safety switch 41 within reservoir 42 which is integral to line 56. If pressurized air and not pressurized oily water is being delivered to the rings 20 in a failure or operator error situation, then the float switch 41 at the top of reservoir 42 would drop due to reservoir 42 now being filled with air. This failure, signaled by switch 41 to the PLC controller would result in the shutting down of all the rings 20.

In the case of a centrally controlled operation, this action would be reported by the PLC controller via modem and phone lines to a server computer at head office.

Reverting to the description, sight-glass reservoir 32 connects through a pipe line 62 to two valves that are teed off this line 62. One line goes to an air line beyond valve 67. The other line is a normally-closed permeate (process water) drain valve 64. Valve 67 is a normally-open air safety valve which is energized and held closed when the processors 20 are operating. In the event of an electrical power failure (or a controlled shut-down), valve 64 closes, locking-in all permeate water and valve 67 rapidly opens, allowing air pressure (at approx. 60 psi) to back-pulse treated permeate water backwards through the ceramic filters, into the rings 20, to off-set the internal oily water pressure in rings 20. This approach greatly lessens the likelihood of oil droplets in the unprocessed water within the rings 20 from fouling the lumen membrane surfaces 25. The off-set pressures means that no oil flows into the membrane surfaces, to foul them.

The first sight-glass reservoir 30 contains a stainless steel float switch 60, and connects with a common line 66 that tees to a normally-closed air line valve 68 and a normally-closed oily concentrate purge valve 70. As oil is concentrated during the operation of the processor oily concentrate is periodically purged out of the system at valve 70. When normally closed valve 70 is opened pressurized air pushes out any liquid in reservoir 30 and ring 20 when a ring bottom drain valve 88 is also opened. Each ring 20 includes a ring flow meter 74 located upstream of the intake to pump 28, for measuring the flow velocity in the ring 20. The maintenance of correct ring flow velocity is important.

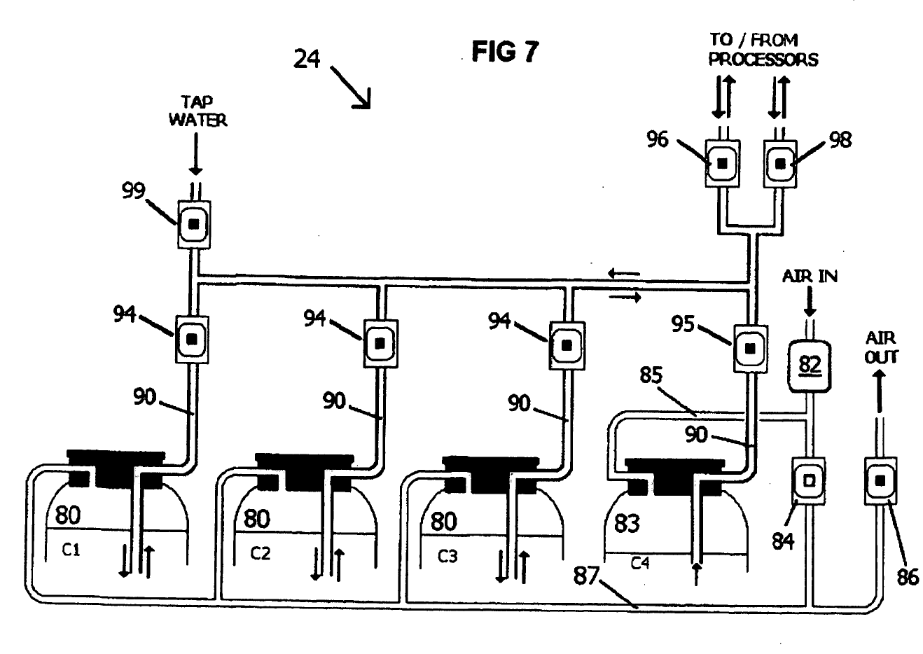

The outlined descriptions can be followed using FIG. 7, together with FIG. 1, FIG. 7 being a detail of the series portion 24 of FIG. 1.

The cleaning liquid series 24 includes three pressure tanks 80 and one pressure tank 83, served by air pressure lines 87 and 85 respectively and operating through common pressure regulator 82. The tanks 80 of chemical solution have their internal pressure controlled by normally-open air supply valve 84, and normally-closed solenoid dump valve 86. Chemical solution tank 83, containing hydrogen peroxide, has no such “in” and “out” air control because the chemical solution content in the tank is simply depleted over time and not reused, hence pressure is applied at all times.

Each tank 80 and 83 has an outlet pipe 90 connecting by a common bus 92 that serves the two rings 20 through ring access valves 96 and 98. Each outlet pipe 90 has a normally-closed solenoid valve 94. A tap water inlet line 97 has a normally-closed solenoid valve 99, that admits rinse water through common bus 92 to the rings 20. A pressure switch 100 is connected to ring 20 and set at a low pressure value as a safety shut down connected to the PLC in the event that ring 20 loses pressure in a critical fault situation.

In FIG. 1A, the location of the lumens within the filter 22, and the lumen membrane filter coatings 25 are shown, together with the filtrate collection annulus 23.

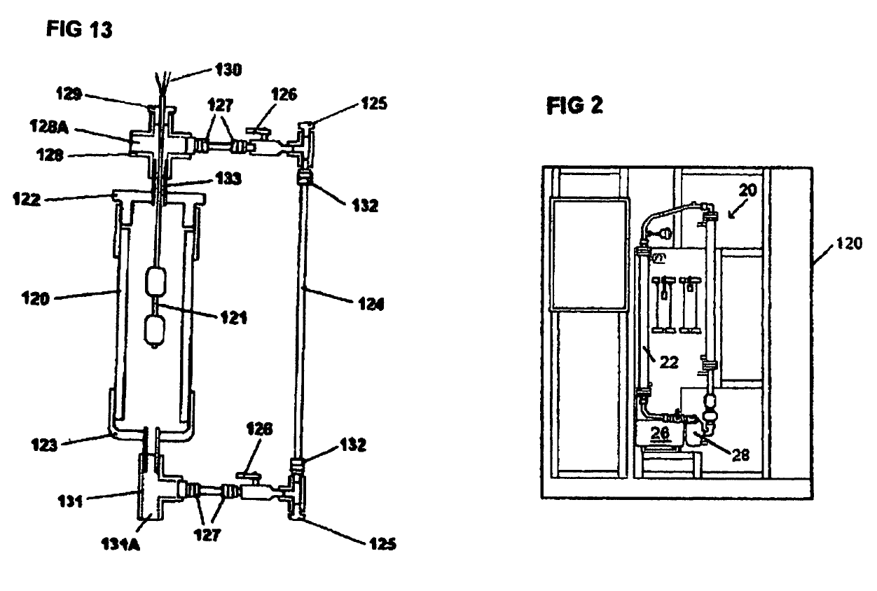

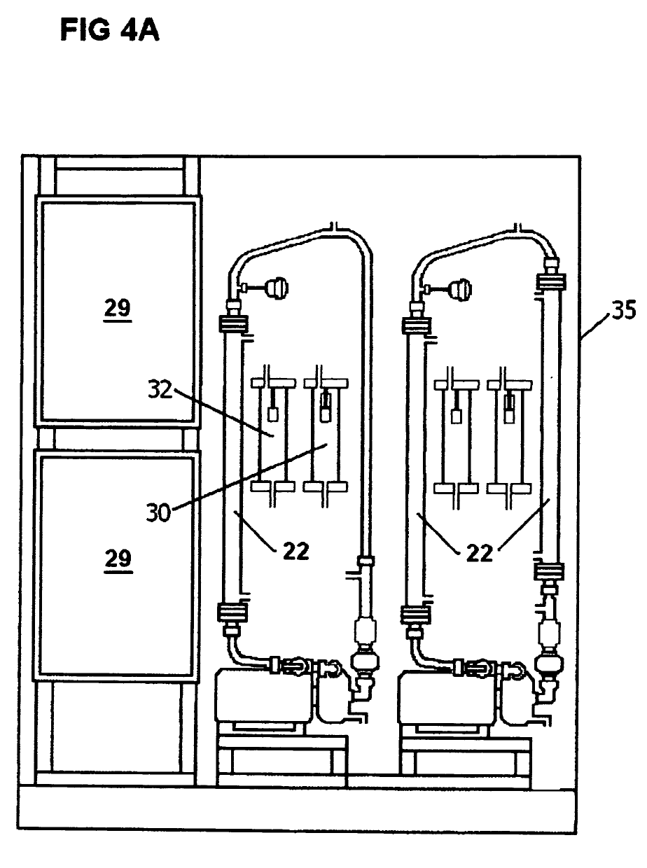

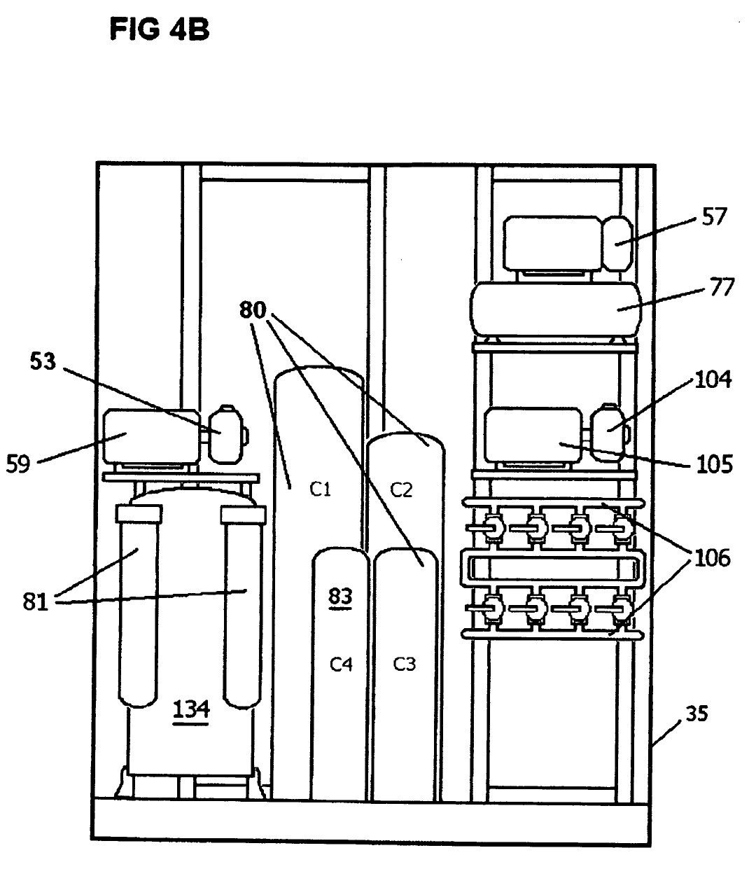

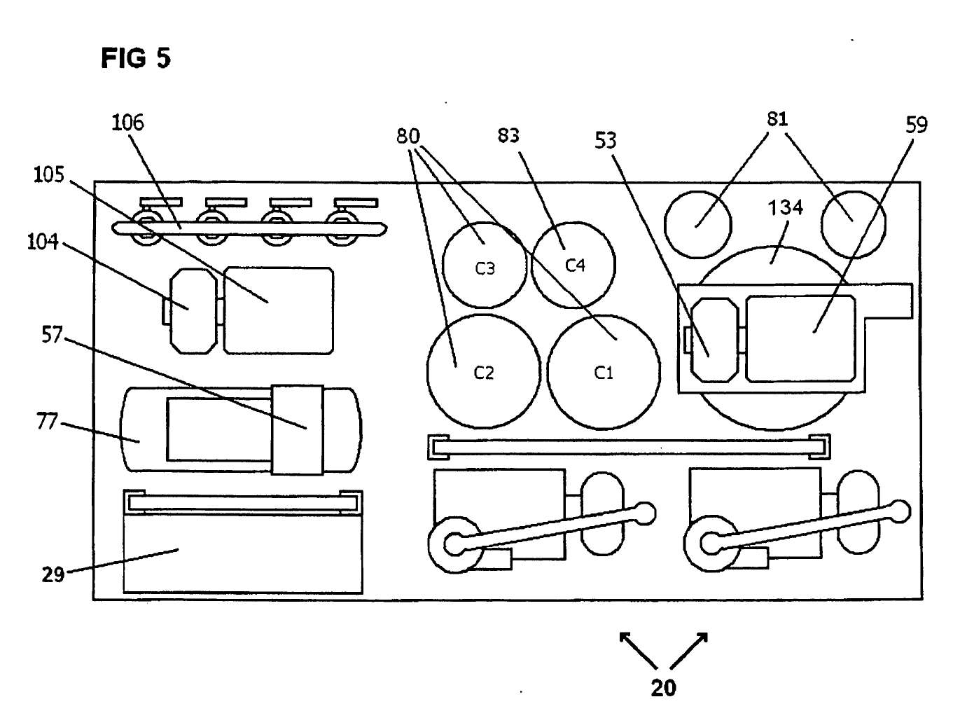

Referring to FIG. 2, the elements of the ring 20 are shown in their respective locations within a cabinet 35. The system ancillary support equipment is contained in the back of the cabinet, being equivalent to that shown in FIGS. 4B and 5. Referring to FIGS. 4B and 5, the ancillary support equipment of the system is contained within the cabinet, being located at the rear of the cabinet, behind the two-ring, two ring arrangement of FIG. 4A. It consists of a pair of 10 micron pre-filters 81; the oily water reservoir 134; a back-up air compressor 57 connected to its air storage tank 77; cleaning chemical reservoirs 80 and 83, and a pump 104 used to transfer liquid between site storage tanks.

Referring to FIG. 3, the oily water feed system 40 has a pressure tank 134 with an oily water inlet 51 connected to pump 53 which moves oily water through 10 micron pre-filters 81 and ultimately through pipe 133 into pressure tank 134. Tank 134 fills under the action of pump 53 until the oily water level rises to reach float switch 46 (HLS). At this point under the control of the PLC, pump 53 stops, air dump valve 54 closes, and air pressure valve 52 opens, re-pressurizing tank 134 which in turn delivers pressurized oily water past delivery tee 129 through water line 56 to rings 20. When the Low Level Switch 48 (LLS) signals that the tank 134 is depleted of feed oily water, the solenoid valve 52 closes, cutting off the pressurized air supply, and the solenoid valve 54 is opened, thus venting the tank 134 to atmosphere. The low level float switch 48 (LLS) then signals the PLC to admit oily feed water to the tank 134 via pump 53, which continues to fill the tank until the high level float switch 46 (HLS) signals the PLC that the tank 134 is full, and the pump 53 stops.

Turning to FIG. 6, the sight-glass reservoirs 30, 32 have a cylindrical sight-glass 110 adjustably secured by bolts 112 and nuts 113 between end plates 114. Elastomeric gaskets 115 provide sealing and resilience to the reservoirs 30, 32. A stainless steel float valve 60 is suspended from the upper end plate 164.

Connection nipples 116 are threaded into the end plates 114, for connecting line 66 at the ring reservoir top outlet and line 62 to the module reservoir top position. The bottom inlet of the reservoir 30 connects to ring 20 at its top position. Reservoir 32 is connected from its bottom connection nipple to the module 22 top position.

FIG. 7 is the functional equivalent of the cleaning liquid assembly 24 and the associated control valves of FIG. 1.

Referring to FIG. 13, in this improved reservoir arrangement, the reservoir 120 has a separate sight glass 124, enabling the use of opaque materials for the reservoir 120. Schedule 80 CPVC (Chlorinated Poly Vinyl Chloride) pipe and pipe fittings are used, which accepts a temperature of 80 Celsius and a pressure of 100 PSI, both being values within the desired upper limits for the UF process during a cleaning sequence as well as within the design parameters of the pipe material.

The sight glass 124 is of extruded clear Teflon tube, secured by polyethylene compression fittings 132. The sight glass is connected to the Oscillating Reservoir 120 at top and bottom. The sight glass is removable for ease of cleaning. Due to the nature of the oily wastes we treat, interior surfaces become dirty and non-transparent. End plugs 125 above and below the sight glass allow rapid cleaning of the sight glass interior with a swab once valves 126 are closed, isolating the sight glass from the rest of the processor. The sight glass assembly is attached to the Oscillating Reservoir proper by brass compression fittings and copper tube 127. Brass pipe fittings 128, 131 connect the sight glass 124 to the Reservoirs 120.

Within the Reservoir 120 a double float switch 121 is integral to the oscillating action of the subject cleaning cycle (see above). Float switch wires 130 lead from each Reservoir to the PLC controller.

Oily waste water or cleaning solutions enter and leave the Reservoir 120 at points 128A and 131A. There is a narrow area 133 that connects the top of the Reservoir at 122 to a brass tee 128. The stem of the double float 121 passes through the centre of this pipe nipple 133 but does not restrict the flow of liquid through this area.

An additional feature of this embodiment is the removable threaded reducer bushing fitting 122. The disconnecting function of this reducer bushing may also be achieved using either a “pipe union” type of fitting or a “flange” connection. Float switches 121 over time become coated with oil and dirt which changes the specific gravity of the float to the point where they no longer float in water and hence can fail to signal the PLC. In the previous Pyrex glass design, the glass pipe was held in place by four corner rods compressing the glass tube against gasketed end plates. This proved exceedingly time consuming to clean as total disassembly was needed. Re-assembly demanded very critical re-torquing of the corner connecting rods. The new embodiment enables the periodic checking of the condition of the floats with a processor downtime of a few minutes only.

Turning to FIGS. 8 through 12, commenting sequentially thereon, the process is normally started and run by the PLC, initiating filling the ring or rings with clean water, such as tap water or permeate, and the recirculation pump 28 operated. The oily water circuit is then operated to fill the ring with oily water, and separation is commenced, with permeate passing to drain on a continuing basis.

The process steps set forth herein are preferably controlled by the PLC, in response to signal inputs from respective sensors, referred to above. It will be understood that such control may be effected manually.

Turning to FIG. 9, in the event of a process interruption, such as a power failure, the loss in power results in the termination of permeate outflow, and the application of air pressure to the permeate, as a back-pressure, as described above. In this condition, with the reinstatement of power or removal of the interrupting factor, the ring pump 28 is restarted, the permeate outflow valve is re-opened, and separation resumed.

Referring to FIG. 10, in order to close down the operation of a ring, the permeate is back pressured, by closure of the permeate outflow valve 64, and opening of air inlet valve 67, to apply air back pressure to the sight glass reservoir 32 (as described above) All pumps and valves are turned off (de-emergised), and the stabilized system is maintained under air pressure, with the permeate under back-pressure, so as to maintain the lumen membrane filter coatings 25 suffused with the permeate water (filtrate), to prevent contamination and blockage by oil droplets depositing on the coatings.

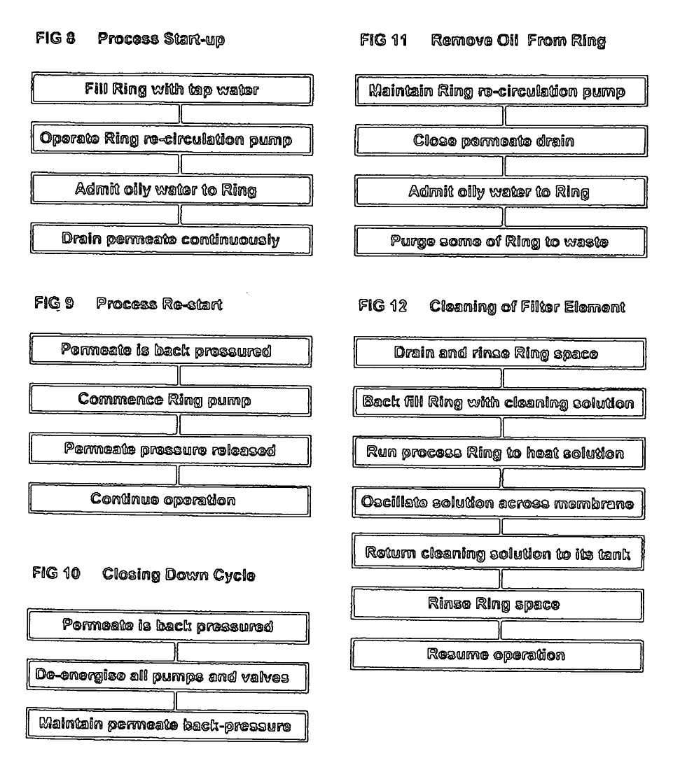

Turning to FIG. 11, the concentrated oily water, with about 90 to 95 percent of the original water removed as permeate water, and having an oil concentration of about 35 to 40 percent, is removed from the ring. During this phase of the operation the ring circulation pump continues to operate. The permeate drain valve 64 is closed, and valve 44 is opened to admit oily water to the ring 20 from the feed system 40. The normally-closed oily concentrate purge valve 70 is opened, to drain off a portion of the concentrated oily water from the ring. The valve 70 is then closed, the permeate drain valve 64 is opened, and the separation process resumed.

Referring to FIG. 12, the ring is drained of oily water, which is replaced by rinse water, either tap water or recycled permeate, and pumped around the ring.

The ring is then back-filled with one of the cleaning solutions selected from the cleaning liquid series 24. The ring access valves are then all closed, and the circulation pump 28 operated, circulating the cleaning solution through the ring to raise its temperature. The cleaning solution is then passed by air pressure gradient, from the sight glass reservoir 30, through the lumen membrane coatings 25 to the sight glass reservoir 32, and then reversed back to the reservoir 30. This oscillation takes place a number of times, and the cleaning cycle then terminated, usually by return of the cleaning solution to its respective tank.

The ring is then re-filled with rinse water, and the pump 28 operated, to flush the ring. The rinse water is then dumped to drain, the ring re-filled with oily water, and the separation cycle is re-commenced.

The system may have a pair of such circulation rings, wherein the cross-flow filter means in each ring consists of a single cross-flow UF filter held within a stainless steel housing.

The system circulation ring may have more than one such cross flow filter means, connected in series flow relation.

The system has at least two auxiliary reservoirs having air supply means connected thereto in selective liquid displacing relation, to pass the cleaning chemicals in said sequential transfer relation, for to-and-fro displacement through the UF filter membrane surfaces.

The system liquid transfer means for transferring the contaminated liquid into the circulation ring includes a pressurized feed tank having a high level switch, a low level switch, and pressure air supply means controlled by the switches, enabling entry of the contaminated liquid into the tank at substantially atmospheric pressure, on actuation of the low level switch, with pressurization of the tank at a pressure above atmosphere upon actuation of the high level switch.

The system cross-flow filter element is sealed within its stainless steel housing by way of double O-ring seals, to withstand reversals in pressure of the cleaning chemicals.

The subject dewatering system is for separating substantially clean liquid from a mixture of the liquid and a contaminating substance intimately mixed with the liquid, consisting of a circulation ring to receive the contaminated liquid in contained relation therein; the ring having a circulation path for circulating passage of contaminated liquid therearound; liquid transfer means for

1. A dewatering system for separating substantially clean liquid from a mixture of the liquid and a contaminating substance intimately mixed with the liquid, consisting of a circulation ring to receive the contaminated liquid in contained relation therein; the ring having a circulation path for circulating passage of contaminated liquid therearound; liquid transfer means for transferring the contaminated liquid into the circulation ring; pump means for circulating the contaminated liquid about the ring circulation path; cross-flow filter means having UF filter membrane surfaces forming a part of the ring circulation path, for receiving the liquid in cross-flow penetrating relation thereacross; liquid receiver means for receiving the penetrating liquid from the filter means; pressurizing means for creating a predetermined pressure drop across said cross-flow filter means, to promote passage of said liquid through said filter means; chemical cleaning means for cleaning said filter means; and control means for admitting chemicals of said cleaning means to said ring and removing said chemicals from said ring.

2. The system as set forth in claim 1 wherein said contaminated mixture is a mixture of water with oil.

3. The system as set forth in claim 1, wherein said chemical cleaning means includes a plurality of chemical reservoirs, said control means including individual control means for each of said reservoirs.

4. The system as set forth in claim 1, said control means for admitting chemicals of said cleaning means being connected with at least two auxiliary reservoirs, one said auxiliary reservoir being connected directly with said ring, and one said auxiliary reservoir being directly connected with said liquid receiver means, for passage of said chemical cleaning means to a said auxiliary reservoir and through said filter membrane surfaces to the other said auxiliary reservoir, wherein said control means provides forward and reverse flow between said auxiliary reservoirs and through said filter membrane surfaces, in cleaning relation therewith.

5. The system as set forth in claim 4, said auxiliary reservoirs each having a sight-glass removably connected therewith, to provide visual reference to the level of liquid within said connected reservoir, and to facilitate cleaning of said sight-glass.

6. The system as set forth in claim 4, said auxiliary reservoirs each having a readily removable end cover portion, to provide ready access within said reservoir for purposes of maintenance.

7. The system as set forth in claim 1, wherein said cross-flow filter means consists of a single ceramic cross-flow filter element held within a stainless steel housing.

8. The system as set forth in claim 1, having a pair of said circulation rings, wherein said cross-flow filter means consists of a single cross-flow filter in each said ring.

9. The system as set forth in claim 1, wherein said cross-flow filter means consists of at least one ceramic cross-flow filter element held within a stainless steel housing.

10. The system as set forth in claim 9, said circulation ring having more than one said cross flow filter means, connected in series flow relation.

11. The system as set forth in claim 4 said at least two auxiliary reservoirs having air supply means connected thereto in selective liquid displacing relation, to pass said cleaning chemicals in said sequential transfer relation, for to-and-fro displacement through said filter membrane surfaces.

12. The system as set forth in claim 1, wherein said liquid transfer means for transferring said contaminated liquid into said circulation ring includes a pressurized feed tank having a high level switch, a low level switch, and pressure air supply means controlled by said switches, enabling entry of said contaminated liquid into said tank at substantially atmospheric pressure, on actuation of said low level switch, with pressurization of said tank at a pressure above atmosphere upon actuation of said high level switch.

13. The system as set forth in claim 7, wherein said single ceramic cross-flow filter element is sealed within said stainless steel housing by way of double O-ring seals, to withstand reversals in pressure of said cleaning chemicals.

14. A dewatering system for separating substantially clean liquid from a mixture of the liquid and a contaminating substance intimately mixed with the liquid, consisting of a circulation ring to receive the contaminated liquid in contained relation therein; the ring having a circulation path for circulating passage of contaminated liquid therearound; liquid transfer means for transferring the contaminated liquid into the circulation ring; pump means for circulating the contaminated liquid about the ring circulation path, when energized; cross-flow filter means having UF filter membrane surfaces forming a part of the ring circulation path, for receiving the liquid in cross-flow penetrating relation thereacross; liquid receiver means for receiving the penetrating liquid from the filter means; pressurizing means for creating a predetermined pressure drop across said cross-flow filter means, to promote passage of said liquid through said filter means; and back pressure means, operable on de-energization of said pump means, to terminate passage of said liquid through said filter means, and to apply backpressure to liquid within said liquid receiver means to thereby suffuse said liquid over said filter membrane surfaces, in protective relation from said contaminated liquid.

15. The system as set forth in claim 14, wherein said backpressure means includes a compressed air reservoir in actuating relation with an outlet valve for said liquid receiver means and with an inlet valve connected in back-pressure applying relation with said liquid receiver means.

16. The method of extracting substantially clear permeate liquid from a contaminated mixture of said liquid and a low concentration of globular contaminant, using a cross-flow UF filter located within a circulatory ring apparatus containing said mixture, including the steps of filling said ring with said contaminated mixture; circulating said mixture around said ring at a sufficient pressure to promote the passage of said liquid as a permeate through said filter in a first direction, while maintaining the passage of said contaminant across the face of said filter; removing said permeate from the apparatus; draining said ring; admitting a cleaning liquid to the ring, and circulating same about the ring under a pressure acting to effect passage of said liquid in said first direction; reversing said pressure to effect passage of said liquid in a direction reverse to said first direction as a cleaning oscillation; repeating said cleaning oscillation; draining said cleaning liquid from the ring; readmitting contaminated mixture to the ring, and repeating said steps.

17. The method as set forth in claim 16, including the step of rinsing said ring with water prior to the initial said filling step; and rinsing with water again, after draining said cleaning liquid from said ring.

18. The method as set forth in claim 16, including the step of monitoring the removal of said permeate, to determine the rate of permeate through-put in relation to a thresh-hold level, and initiating a cleaning sequence commencing with said step of draining said ring, to promote said rate of permeate throughput.

19. The method as set forth in claim 18, including the step of further monitoring said removal of said permeate, to determine the rate of permeate through-put in relation to said thresh-hold level, and initiating a further cleaning sequence commencing with said step of draining said ring, to further promote said rate of permeate throughput.

20. The method as set forth in claim 18, wherein said step of circulating said mixture around said ring includes electrically energizing a pump means to circulate said mixture; including, in the event of said pump means becoming de-energized, the steps of terminating said removal of permeate from said apparatus, and applying air pressure to said apparatus to displace said permeate in suffusing relation across said face of said filter, in protective relation with said face against penetration of said contaminated mixture into said face.
